(19) United States
(12) Patent Application Publication
(10) Pub. No.: US 2025/0233230 A1
(43) Pub. Date: Jul. 17, 2025

(54) SCALABLE COOLING STRUCTURE FOR A BATTERY CELL

(71) Applicant: Caterpillar Inc., Peoria, IL (US)

(72) Inventors: Tiwari Arpan RAMESHBHAI, Ahmedabad (IN); Peitong JIN, Dunlap, IL (US); Richu GHEEVARGHESE SAMUEL, Alappuzha (IN); Bhavin Nareshkumar MEHTA, Bangalore (IN); Krishna Prasath RAMABADHRAN, Bangalore (IN)

(73) Assignee: Caterpillar Inc., Peoria, IL (US)

(21) Appl. No.: 18/410,348

(22) Filed: Jan. 11, 2024

(51) Int. Cl. H01M 10/6556; H01M 10/613; H01M 10/647; H01M 10/6554; H01M 10/6568; H01M 50/211

(52) U.S. Cl. CPC H01M 10/6556; H01M 10/613; H01M 10/647; H01M 10/6554; H01M 10/6568; H01M 50/211

(57) ABSTRACT

A battery assembly may include a cooling sleeve having a first cooling plate with a first fluid channel defined in the first cooling plate, a second cooling plate with a second fluid channel defined in the second cooling plate, and a chamber defined between the first cooling plate and the second cooling plate. The battery assembly may include a battery cell disposed in the chamber between the first cooling plate and the second cooling plate.

### TECHNICAL FIELD

The present disclosure relates generally to batteries and, for example, to a scalable cooling structure for a battery cell.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells. One type of battery cell is a pouch cell, which includes a battery device contained in a flexible pouch. The pouch provides little protection and may allow the pouch cell to be folded, bent, or otherwise damaged under some operating conditions. Accordingly, a pouch cell may be used with a structural support to protect the pouch cell and to allow multiple pouch cells to be stacked together. However, the structural support may place constraints on cooling systems that can be used with the cell stack to dissipate heat. In some approaches, a bottom cooling plate may be coupled to the cell stack to provide cooling at edges of the cells, or face cooling may be achieved using a cooling plate attached to the faces of one or two cells. However, these approaches generally lack modularity (e.g., lack adaptability to changes to a size or a configuration of a cell stack), scalability (e.g., lack adaptability to changes to a size of a cell), and cooling uniformity.

U.S. Pat. No. 10,038,226 (the '226 patent) discloses a cooling plate for a battery pack with a plurality of battery cells. The cooling plate of the '226 patent includes a cooling fin with a substantially planar surface and a perimeter. The cooling plate includes a frame abutting the cooling fin and forming a seal with the cooling fin adjacent the perimeter of the cooling fin. The frame and the cooling fin define at least one fluid inlet, at least one fluid outlet, and a flow channel therebetween.

The cooling plate of the '226 patent provides a single thermal interface for the battery cells. Accordingly, the heat dissipation that can be provided by the cooling plate is limited by the single thermal interface. Furthermore, the cooling plate of the '226 patent uses a separate frame to provide structural support for the battery cells, thereby adding bulkiness to the battery pack and/or reducing an achievable battery cell density of the battery pack.

The cooling structure of the present disclosure solves one or more of the problems set forth above and/or other problems in the art.

### SUMMARY

A battery assembly may include a cooling sleeve having a first cooling plate with a first fluid channel defined in the first cooling plate, a second cooling plate with a second fluid channel defined in the second cooling plate, and a chamber defined between the first cooling plate and the second cooling plate. The battery assembly may include a battery cell disposed in the chamber between the first cooling plate and the second cooling plate.

A cooling sleeve for a battery cell may include a first cooling plate having a first fluid inlet, a first fluid outlet, and a first fluid channel defined in the first cooling plate between the first fluid inlet and the first fluid outlet. The cooling sleeve may include a second cooling plate having a second fluid inlet, a second fluid outlet, and a second fluid channel defined in the second cooling plate between the second fluid inlet and the second fluid outlet. The first cooling plate may be joined to the second cooling plate to define a chamber, between the first cooling plate and the second cooling plate, configured to receive the battery cell.

A battery module may include a first battery assembly including a cooling sleeve having a first cooling plate with a first fluid channel defined in the first cooling plate, a second cooling plate with a second fluid channel defined in the second cooling plate, and a chamber defined between the first cooling plate and the second cooling plate. The battery assembly may include a battery cell disposed in the chamber between the first cooling plate and the second cooling plate. The battery module may include a second battery assembly in a stacked configuration with the first battery assembly.

### BRIEF DESCRIPTION OF THE DRAWINGS

FIG. 1 is a diagram of an example battery pack.

FIG. 2 is a perspective view of an example battery assembly.

FIG. 3 is a partially exploded view of an example battery assembly.

FIG. 4 is an end view of an example battery assembly.

FIG. 5 is a front view of an example cooling plate.

FIG. 6 is a perspective view of an example battery assembly stack.

### DETAILED DESCRIPTION

This disclosure relates to a battery assembly, battery module, and/or battery pack, and is applicable to any machine application that uses power provided by a battery. For example, the machine may perform an operation associated with an industry, such as mining, construction, farming, transportation, or any other industry. For example, the machine may be an electric or hybrid vehicle, or an electric or hybrid work machine (e.g., a compactor machine, a paving machine, a cold planer, a grading machine, a backhoe loader, a wheel loader, a harvester, an excavator, a motor grader, a skid steer loader, a tractor, and/or a dozer), among other examples. Additionally, or alternatively, the battery assembly, battery module, and/or battery pack described herein may be used in an energy storage application, such as for solar energy storage and/or wind energy storage, among other examples. As used herein, “battery cell,” “battery,” and “cell” may be used interchangeably.

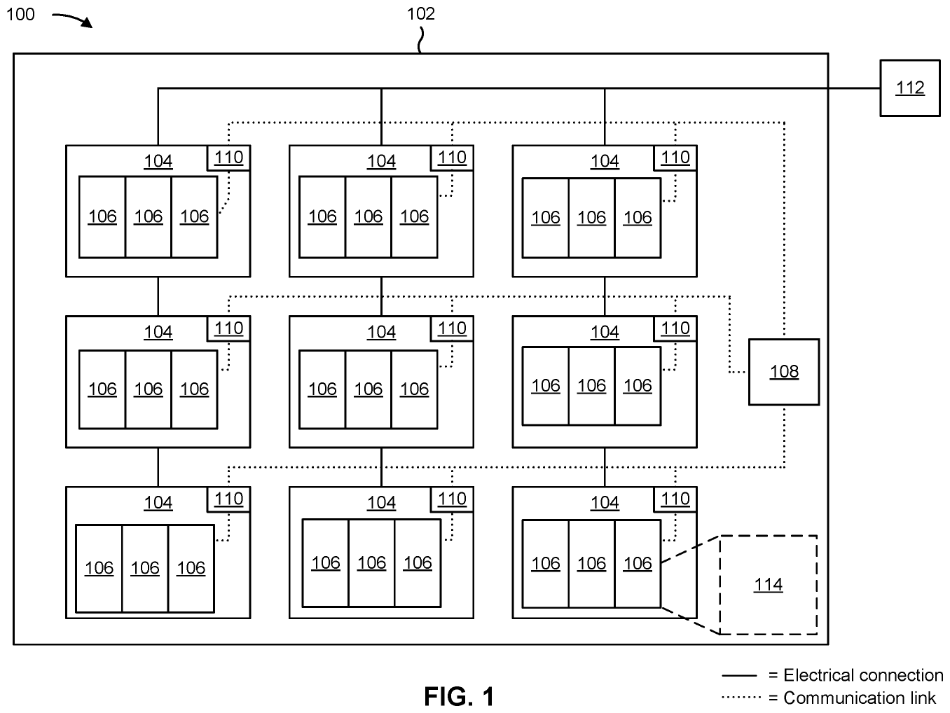

FIG. 1 is a diagram of an example battery pack 100. The battery pack 100 may include a battery pack housing 102, one or more battery modules 104, and one or more battery assemblies 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as a computing system or an electric motor, among other examples. As another example, the component 112 provides energy to the battery pack 100 (e.g., to be stored by the battery assemblies 106). In such examples, the component 112 may be a power generator, a solar energy system, and/or a wind energy system, among other examples.

The battery pack housing 102 may include metal shielding (e.g., steel, aluminum, or the like) to protect elements (e.g., battery modules 104, battery assemblies 106, the battery pack controller 108, the module controllers 110, wires, circuit boards, or the like) positioned within battery pack housing 102. Each battery module 104 includes one or more (e.g., a plurality of) battery assemblies 106 (e.g., positioned within a housing of the battery module 104). As shown, a battery assembly 106 includes a battery cell 114. Battery cells 114 may be connected in series and/or in parallel within the battery module 104 (e.g., via terminal-to-busbar welds). Each battery cell 114 is associated with a chemistry type. The chemistry type may include lithium ion (Li-ion) (e.g., lithium ion polymer (Li-ion polymer), lithium iron phosphate (LFP), and/or nickel manganese cobalt (NMC)), nickel-metal hydride (NiMH), and/or nickel cadmium (NiCd), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery assemblies 106 included in each battery module 104, and the number of battery modules 104 included in the battery pack 100 (e.g., and the relative serial and/or parallel connections of the battery cells 114 and/or the battery modules 104) may be associated with the required output power and an intended use of the battery pack 100. For example, any number of battery cells 114 can be included in a battery module 104. Similarly, any number of battery modules 104 can be included in the battery pack 100.

As indicated above, FIG. 1 is provided as an example. Other examples may differ from what is described with regard to FIG. 1.

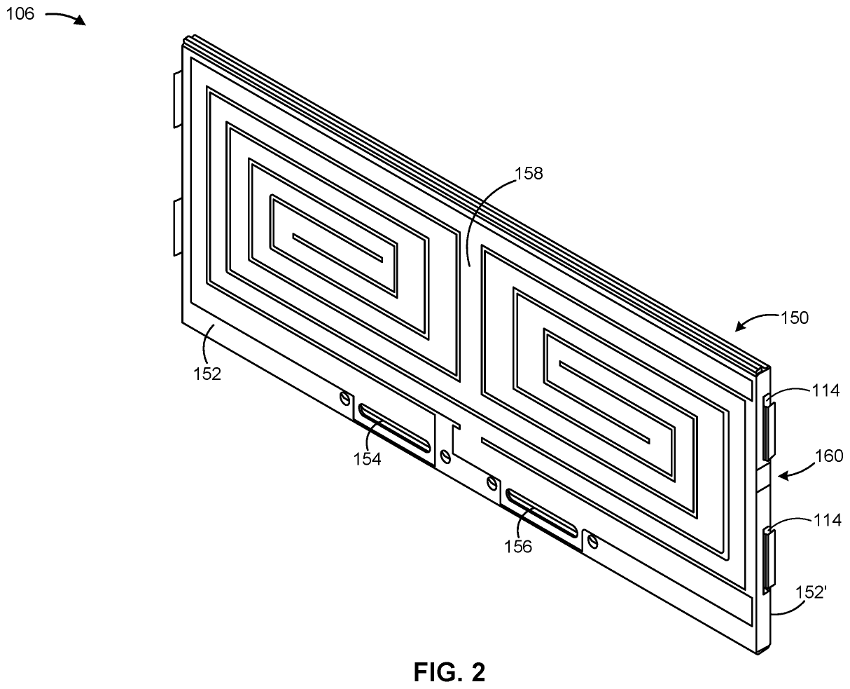

FIG. 2 is a perspective view of an example battery assembly 106. As shown, the battery assembly 106 includes a cooling sleeve 150 and one or more battery cells 114 disposed inside the cooling sleeve 150. The cooling sleeve 150 is configured to structurally support and protect the battery cells 114 disposed inside the cooling sleeve 150, while also improving heat dissipation from the battery cells 114. A battery cell 114 may be a pouch cell. In some implementations, a battery cell 114 may be a prismatic cell.

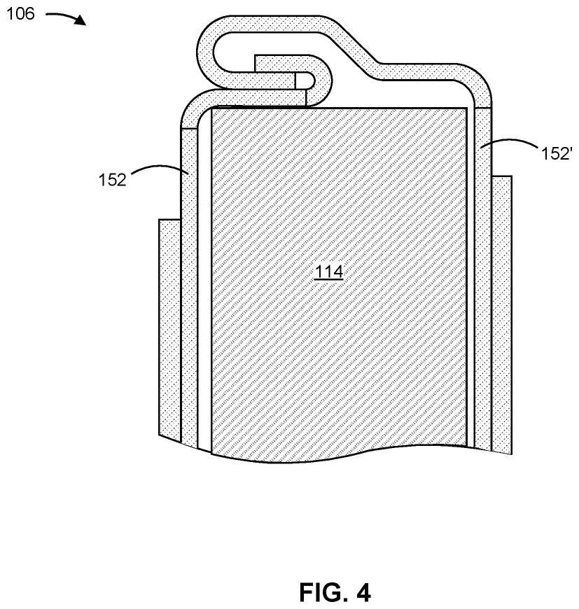

The cooling sleeve 150 has a first cooling plate 152 and a second cooling plate 152′. The cooling plates 152, 152′ may be composed of a rigid, thermally conductive material, such as a metal, a metal alloy, graphite, or the like. The first cooling plate 152 may be spaced apart from, and arranged approximately parallel to, the second cooling plate 152′. Moreover, the first cooling plate 152 may be joined to the second cooling plate 152′. For example, the first cooling plate 152 and the second cooling plate 152′ may be separate parts that are attached together by interlocking features (as described in connection with FIG. 4), welding, straps, and/or fasteners (e.g., bolts), among other examples. Alternatively, the first cooling plate 152 and the second cooling plate 152′ may be respective sides of a single folded plate. For example, the cooling sleeve 150 may include a single plate with a fold (e.g., down an approximate center of the single plate to define two approximate halves of the single plate) to define the first cooling plate 152 at a first side of the fold and the second cooling plate 152′ at a second side of the fold.

The first cooling plate 152 has a fluid inlet 154, a fluid outlet 156, and a fluid channel 158 defined in the first cooling plate 152 between the fluid inlet 154 and the fluid outlet 156. For example, the fluid inlet 154, the fluid outlet 156, and the fluid channel 158 are configured to direct a fluid coolant (e.g., water) entering the fluid inlet 154 through the fluid channel 158 and out the fluid outlet 156. Similarly, the second cooling plate 152′ has a fluid inlet 154′, a fluid outlet 156′, and a fluid channel 158′ (all of which are not visible in FIG. 2) defined in the second cooling plate 152′ between the fluid inlet 154′ and the fluid outlet 156′. The fluid inlets 154, 154′ may be similarly configured, the fluid outlets 156, 156′ may be similarly configured, and the fluid channels 158, 158′ may be similarly configured. For example, the first cooling plate 152 and the second cooling plate 152′ may be copies of each other. The fluid inlet 154 is in fluid communication with the fluid inlet 154′, and the fluid outlet 156 is in fluid communication with the fluid outlet 156′.

A chamber 160 is defined between the first cooling plate 152 and the second cooling plate 152′. For example, the cooling sleeve 150 may have a hollow interior region (e.g., a pocket) that defines the chamber 160. The chamber 160 is configured to receive the one or more battery cells 114. For example, the one or more battery cells 114 may be disposed in the chamber 160 between the first cooling plate 152 and the second cooling plate 152′. For example, multiple battery cells 114 (e.g., two battery cells 114, four battery cells 114, or eight battery cells 114, among other examples) may be disposed in the chamber 160. A battery cell 114 disposed in the chamber 160 may be thermally interfaced with the first cooling plate 152 and the second cooling plate 152′ (e.g., the cooling sleeve 150 provides two thermal interfaces), such that heat may be dissipated from multiple sides of the battery cell 114. For example, a first side (e.g., a first face) of the battery cell 114 may contact the first cooling plate 152, and a second side (e.g., a second face) of the battery cell 114, opposite the first side, may contact the second cooling plate 152′.

Other than the cooling sleeve 150, the battery assembly 106 does not include a frame or other support for the battery cells 114. For example, the cooling sleeve 150 is configured to structurally support the battery cells 114 without a separate frame. Thus, the cooling sleeve 150 has the dual functionality of supporting and cooling the battery cells 114.

As indicated above, FIG. 2 is provided as an example. Other examples may differ from what is described with regard to FIG. 2.

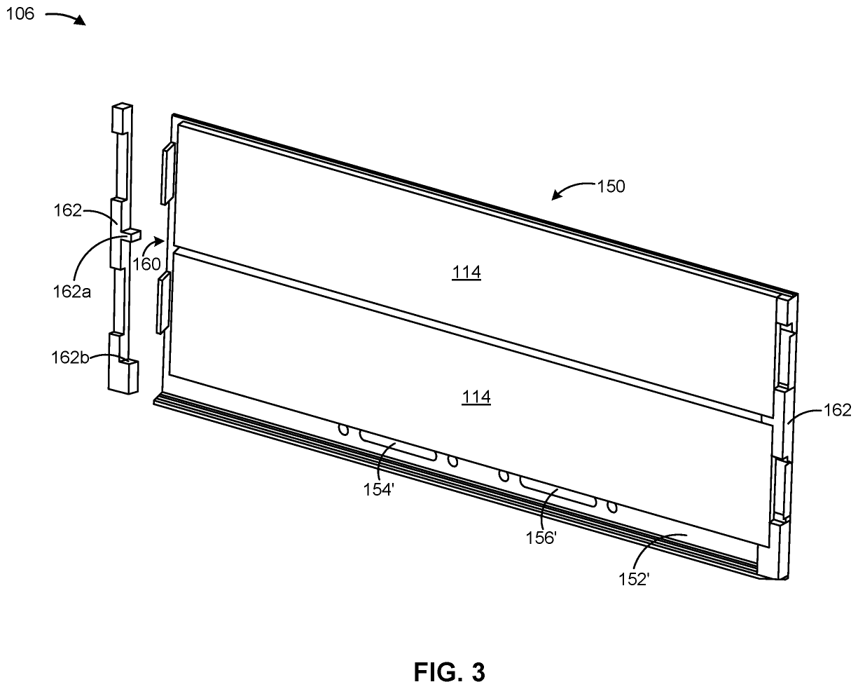

FIG. 3 is a partially exploded view of an example battery assembly 106. In particular, FIG. 3 shows the battery assembly 106, described in connection with FIG. 2, without the first cooling plate 152 to illustrate the interior of the cooling sleeve 150. As shown, multiple battery cells 114 disposed in the chamber 160 may be spaced apart from each other so as not to contact each other. To achieve this spacing of the battery cells 114, the battery assembly 106 may include one or more positioning elements 162. The positioning elements 162 may be composed of plastic or another insulating material. A positioning element 162 may include an elongate strip defining one or more recesses configured to receive respective terminal tabs of one or more battery cells 114. The positioning element 162 may be configured to position the battery cell(s) 114 in the chamber 160. A first positioning element 162 may be engaged with first ends of the battery cell(s) 114, and a second positioning element 162 may be engaged with second ends of the battery cell(s) 114.

Furthermore, a positioning element 162 may define a middle ledge 162a configured to separate an upper battery cell 114 and a lower battery cell 114 (e.g., the upper battery cell 114 may rest on the middle ledge 162a) and/or a bottom ledge 162b configured to raise the lower battery cell 114 from the bottom of the cooling sleeve 150. For example, the positioning element 162 may position the battery cells 114 clear of the fluid inlets 154, 154′ and the fluid outlets 156, 156′ near the bottom of the cooling sleeve 150. As an example, the positioning element 162 may position the battery cells 114 to define a void region running along the bottom of the cooling sleeve 150 so as not to obstruct the fluid inlets 154, 154′ and the fluid outlets 156, 156′. In this way, the positioning elements 162 facilitate guiding of the battery cells 114 into a desired arrangement when the battery cells 114 are being slid into the chamber 160 of the cooling sleeve 150.

In some implementations, the battery assembly 106 may include a spacer block (not shown) disposed in the void region and running along the bottom of the cooling sleeve 150 between the positioning elements 162 and extending between the first cooling plate 152 and the second cooling plate 152′. The spacer block may include fluid passageways to fluidly connect the fluid inlets 154, 154′ and to fluidly connect the fluid outlets 156, 156′. In some examples, the spacer block may be attached to one or both of the positioning elements 162.

The first cooling plate 152 and the second cooling plate 152′ apply a compression pressure (e.g., generated by the interlocking features, welds, straps, or fasteners, among other examples, that attach the first cooling plate 152 and the second cooling plate 152′) to the battery cell(s) 114, position element(s) 162, and/or spacer block disposed in the chamber 160, thereby joining the battery assembly 106 together as a single unit. Moreover, the compression pressure improves a thermal connection between the battery cell(s) 114 and the cooling plates 152, 152′.

As indicated above, FIG. 3 is provided as an example. Other examples may differ from what is described with regard to FIG. 3.

FIG. 4 is an end view of an example battery assembly 106. In particular, FIG. 4 shows one implementation of the battery assembly 106, described in connection with FIG. 2. As shown, the first cooling plate 152 and the second cooling plate 152′ may be separate parts that are attached together by interlocking features. For example, the first cooling plate 152 may have a rolled edge that interlocks with a rolled edge of the second cooling plate 152′, as shown. FIG. 4 shows the interlocking features with respect to top edges of the first cooling plate 152 and the second cooling plate 152′. Similarly interlocking features may also be employed at bottom edges of the first cooling plate 152 and the second cooling plate 152′. The interlocking features provide for connection of the first cooling plate 152 and the second cooling plate 152′, thereby forming the cooling sleeve 150.

As indicated above, FIG. 4 is provided as an example. Other examples may differ from what is described with regard to FIG. 4.

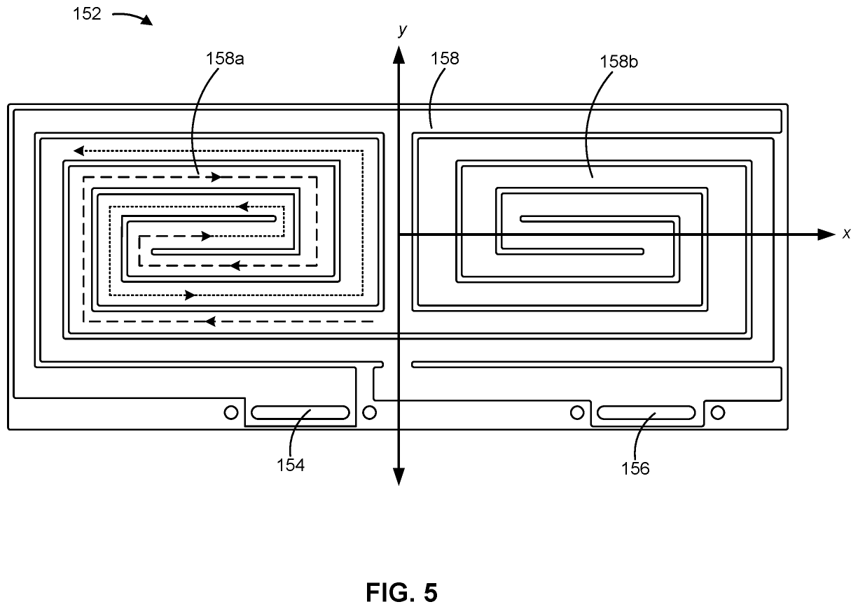

FIG. 5 is a front view of an example cooling plate 152. The cooling plate 152 may correspond to the first cooling plate 152 and/or the second cooling plate 152′. Alternatively, in some implementations, the cooling plate 152 may be the sole cooling plate of a battery assembly (e.g., the cooling plate 152 may be surrounded by a frame, and battery cells may be held against either side of the cooling plate 152 by the frame). As shown, the fluid channel 158 may have a spiral configuration (e.g., a serpentine configuration). The fluid channel 158 may have a single path, or may have multiple parallel paths 158a, 158b as shown, where each parallel path 158a, 158b has a spiral configuration. For example, with multiple parallel paths 158a, 158b, fluid entering the fluid inlet 154 may be split into a first portion that circulates through the parallel path 158a and a second portion that circulates through the parallel path 158b. The first portion and the second portion of the fluid may then be rejoined before exiting the fluid outlet 156.

A path of the fluid channel 158 (e.g., parallel path 158a or parallel path 158b) may have a first section (shown in a dashed line) that spirals inward (e.g., from the fluid inlet 154) according to a first spiraling direction, followed by a second section (shown in dotted line) that spirals outward (e.g., toward the fluid outlet 156) according to a second spiraling direction that is opposite to the first spiraling direction. For example, the first spiraling direction may be one of clockwise or counterclockwise, and the second spiraling direction may be the other of clockwise or counterclockwise. The spiral configurations of the multiple parallel paths 158a, 158b may be symmetric (e.g., spiral symmetric) about a first axis (e.g., the x-axis shown) and/or symmetric about a second axis orthogonal to the first axis (e.g., the y-axis shown). By using a spiral configuration, the fluid channel 158 simply can be widened or narrowed in order to configure the cooling plate 152 for use with variously sized battery cells 114.

As indicated above, FIG. 5 is provided as an example. Other examples may differ from what is described with regard to FIG. 5.

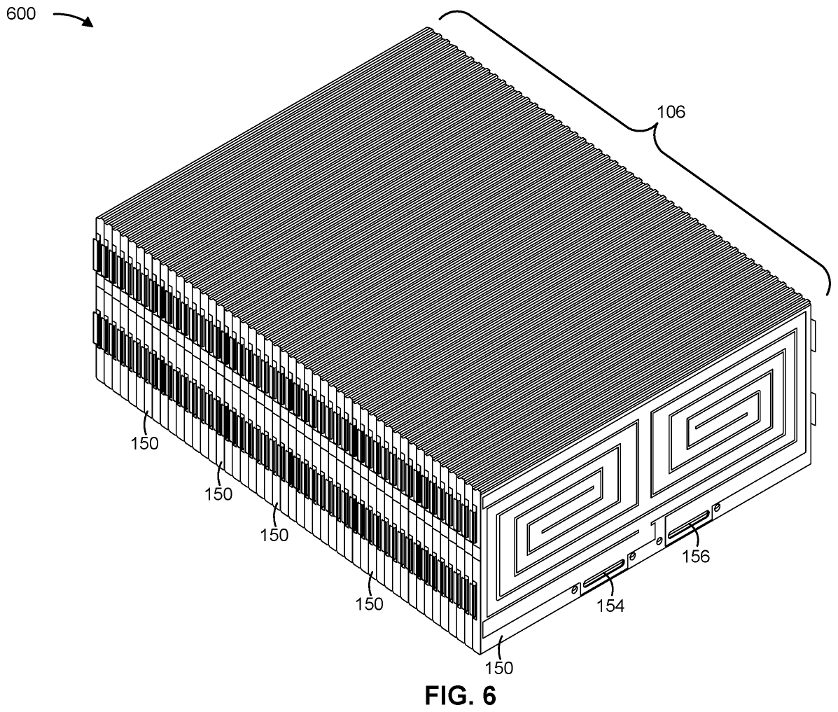

FIG. 6 is a perspective view of an example battery assembly stack 600. The battery assembly stack 600 includes a plurality of battery assemblies 106 arranged side-by-side. For example, the battery assembly stack 600 includes at least a first battery assembly 106 and a second battery assembly 106 in a stacked configuration with the first battery assembly 106. The structural support provided by the cooling sleeves 150 of the battery assemblies 106 enables the cooling sleeves 150 to be arranged in a stack. Furthermore, because the cooling sleeves 150 provide cooling, in addition to structural support, the battery assembly stack 600 can omit separate cooling plates, that would otherwise add additional size and complexity to the battery assembly stack 600. A quantity of the battery assemblies 106 in the battery assembly stack 600 may be based on an overall voltage and/or energy capacity to be produced by the battery assembly stack 600 (e.g., in accordance with a series or parallel electrical configuration). In this way, the battery assemblies 106 facilitate modularity to achieve any desired configuration and power rating for the battery module 104.

In the stack, the fluid inlets 154 of the cooling sleeves 150 may be aligned, and the fluid outlets 156 of the cooling sleeves 150 may be aligned, to form continuous fluid passageways. The battery assembly stack 600 may be included in a battery module 104. For example, the battery module 104 may include a housing (not shown) that encloses the battery assembly stack 600. The housing may include a fluid inlet that is fluidly coupled with the fluid inlets 154 of the cooling sleeves 150 and a fluid outlet that is fluidly coupled with the fluid outlets 156 of the cooling sleeves, thereby forming a fluid circuit of the battery module 104. The housing may also include one or more busbars (not shown) configured to electrically connect the battery cells 114 (e.g., at terminal tabs thereof) of the battery assemblies 106 of the battery assembly stack 600.

As indicated above, FIG. 6 is provided as an example. Other examples may differ from what is described with regard to FIG. 6.

### INDUSTRIAL APPLICABILITY

The battery assembly described herein may be used in any battery module used to power a load or used for energy storage. For example, the battery assembly may be used in a battery module used to power an electric or hybrid vehicle or work machine, or for use in an energy storage application (e.g., associated with solar or wind power generation, or the like). As described herein, the battery assembly may include a battery cell, such as a pouch cell (e.g., a large format cell). A pouch cell may be used with a structural support to protect the pouch cell and to allow multiple pouch cells to be stacked together. However, the structural support may place constraints on cooling systems that can be used with a cell stack to dissipate heat. For example, approaches to provide cell cooling generally lack modularity, scalability, and cooling uniformity. As an example, approaches that provide only a single thermal interface (e.g., single sided cooling of battery cells) lead to higher temperatures and abnormal thermal behavior of battery cells as well as temperature gradients and hot spots across a battery cell stack. Moreover, poorly supported battery cells along with higher temperatures can lead to mechanical and thermal stresses on the battery cells, thereby reducing battery cell life.

The cooling structure described herein is useful for supporting and cooling battery cells. In particular, a battery assembly may include one or more battery cells disposed in a cooling sleeve. The cooling sleeve may provide structural support (e.g., structural rigidity) for the battery cells while also improving heat dissipation from the battery cells. For example, the cooling sleeve provides two thermal interfaces to achieve heat dissipation from two faces of a battery cell (e.g., the cooling sleeve provides a larger heat dissipating surface area than a single cooling plate). Furthermore, the cooling sleeve may employ fluid paths in a spiral configuration that provide uniform heat dissipation (e.g., approximately equal cooling to each battery cell disposed in the cooling sleeve) and are scalable (e.g., in a horizontal and/or vertical dimension) to accommodate battery cells of various sizes or according to various standards. For example, interfacing each battery cell with an approximately equal flow area for coolant minimizes temperature gradients and reduces thermal propagation in a battery module (e.g., thereby reducing a likelihood of thermal runaway).

Because the cooling sleeves provide cooling, in addition to structural support, a battery assembly stack can omit a frame and/or standalone cooling plates, that would otherwise add additional size and complexity to the battery assembly stack. Accordingly, the cooling sleeves reduce bulk (e.g., increase volumetric and galvanometric energy density), improve modularity, and enable stacking of any number of battery assemblies to achieve a battery module according to a desired configuration. Moreover, the modular nature of the battery assemblies facilitate easy assembling of the battery assemblies into a battery assembly stack and easy disassembling of the battery assembly stack (e.g., to enable inspection for fluid leaks or electrical failures).

What is claimed is:

1. A battery assembly, comprising:
a cooling sleeve having a first cooling plate with a first fluid channel defined in the first cooling plate, a second cooling plate with a second fluid channel defined in the second cooling plate, and a chamber defined between the first cooling plate and the second cooling plate; and
a battery cell disposed in the chamber between the first cooling plate and the second cooling plate.

2. The battery assembly of claim 1, wherein a first side of the battery cell contacts the first cooling plate and a second side of the battery cell, opposite the first side, contacts the second cooling plate.

3. The battery assembly of claim 1, wherein the battery cell is a first battery cell, and
wherein the battery assembly further comprises a second battery cell disposed in the chamber between the first cooling plate and the second cooling plate.

4. The battery assembly of claim 3, further comprising:
a positioning element engaged with an end of the first battery cell and an end of the second battery cell,
wherein the positioning element spaces the first battery cell from the second battery cell.

5. The battery assembly of claim 1, wherein a fluid channel, of the first fluid channel or the second fluid channel, has a spiral configuration.

6. The battery assembly of claim 5, wherein a path of the fluid channel has a first section that spirals inward according to a first spiraling direction, followed by a second section that spirals outward according to a second spiraling direction opposite to the first spiraling direction.

7. The battery assembly of claim 1, wherein the battery cell is a pouch cell.

8. The battery assembly of claim 1, wherein the cooling sleeve is configured to structurally support the battery cell without a separate frame.

9. A cooling sleeve for a battery cell, comprising:
a first cooling plate having a first fluid inlet, a first fluid outlet, and a first fluid channel defined in the first cooling plate between the first fluid inlet and the first fluid outlet; and
a second cooling plate having a second fluid inlet, a second fluid outlet, and a second fluid channel defined in the second cooling plate between the second fluid inlet and the second fluid outlet,
the first cooling plate joined to the second cooling plate to define a chamber, between the first cooling plate and the second cooling plate, configured to receive the battery cell.

10. The cooling sleeve of claim 9, wherein the first cooling plate has a rolled edge that interlocks with a rolled edge of the second cooling plate.

11. The cooling sleeve of claim 9, wherein the cooling sleeve comprises a single plate with a fold to define the first cooling plate at a first side of the fold and the second cooling plate at a second side of the fold.

12. The cooling sleeve of claim 9, wherein a fluid channel, of the first fluid channel or the second fluid channel, has a spiral configuration that is symmetrical about a first axis and a second axis orthogonal to the first axis.

13. The cooling sleeve of claim 9, wherein a fluid channel, of the first fluid channel or the second fluid channel, has multiple parallel paths, and
wherein each parallel path, of the multiple parallel paths, has a first section that spirals inward according to a first spiraling direction, followed by a second section that spirals outward according to a second spiraling direction opposite to the first spiraling direction.

14. A battery module, comprising:
a first battery assembly, comprising:
a cooling sleeve having a first cooling plate with a first fluid channel defined in the first cooling plate, a second cooling plate with a second fluid channel defined in the second cooling plate, and a chamber defined between the first cooling plate and the second cooling plate; and
a battery cell disposed in the chamber between the first cooling plate and the second cooling plate; and
a second battery assembly in a stacked configuration with the first battery assembly.

15. The battery module of claim 14, wherein a first side of the battery cell contacts the first cooling plate and a second side of the battery cell, opposite the first side, contacts the second cooling plate.

16. The battery module of claim 14, wherein the first fluid channel is between a first fluid inlet and a first fluid outlet in the first cooling plate, and the second fluid channel is between a second fluid inlet and a second fluid outlet in the second cooling plate.

17. The battery module of claim 16, further comprising:
a positioning element engaged with an end of the battery cell,
wherein the positioning element is configured to position the battery cell in the chamber.

18. The battery module of claim 16, wherein the first fluid inlet is in fluid communication with the second fluid inlet, and the first fluid outlet is in fluid communication with the second fluid outlet.

19. The battery module of claim 14, wherein a path of a fluid channel, of the first fluid channel or the second fluid channel, has a first section that spirals inward according to a first spiraling direction, followed by a second section that spirals outward according to a second spiraling direction opposite to the first spiraling direction.

20. The battery module of claim 14, wherein the cooling sleeve is configured to structurally support the battery cell without a separate frame.
